(19) United States
(12) Patent Application Publication
(10) Pub. No.: US 2026/0326787 A1
(43) Pub. Date: Oct. 22, 2026

(54) INFORMATION PROCESSING DEVICE, VEHICLE, VEHICLE CONTROL METHOD, AND STORAGE MEDIUM

(71) Applicant: MITSUBISHI ELECTRIC CORPORATION, Tokyo (JP)

(72) Inventors: Miki ARAI, Tokyo (JP); Dongsuk PARK, Tokyo (JP); Takayasu HASHIMOTO, Tokyo (JP); Yuri KUBOTA, Tokyo (JP); Misato WATANABE, Tokyo (JP)

(73) Assignee: MITSUBISHI ELECTRIC CORPORATION, Tokyo (JP)

(21) Appl. No.: 19/466,580

(22) Filed: Feb. 2, 2026

Related U.S. Application Data
(63) Continuation of application No. PCT/JP2023/029141, filed on Aug. 9, 2023.

(51) Int. Cl. B60W 60/00; B60W 30/06

(52) U.S. Cl. CPC B60W 60/00133; B60W 30/06; B60W 2540/22; B60W 2540/221; B60W 2552/35

(57) ABSTRACT

An information processing device according to the present disclosure includes an estimation unit that estimates the sleep depth of a user riding in a vehicle, using sensor information acquired by a sensor that detects at least one of the state of the user or the environment around the user, and a control information generation unit that generates control information to be used to control travel of the vehicle by automatic driving, using the sleep depth estimated by the estimation unit.

### CROSS-REFERENCE TO RELATED APPLICATION

This application is a continuation application of International Application PCT/JP2023/029141, filed on Aug. 9, 2023, and designating the U.S., the entire contents of which are incorporated herein by reference.

### BACKGROUND OF THE INVENTION

### 1. Field of the Invention

The present disclosure relates to an information processing device that controls a vehicle, a vehicle, a vehicle control method, and a storage medium.

### 2. Description of the Related Art

A user who rides in a vehicle sometimes sleeps while riding in the vehicle. Japanese Patent Application Laid-open No. 2019-131109 describes a technique to prevent disturbance to a vehicle occupant's sleep in a series hybrid vehicle. The vehicle described in Japanese Patent Application Laid-open No. 2019-131109 can generate electric power with an electric motor, using power of an engine, and disables electric power generation before and after the start of the occupant's sleep. Thus, the vehicle described in Japanese Patent Application Laid-open No. 2019-131109 prevents the occurrence of changes in vibration and noise due to electric power generation before and after the start of the occupant's sleep in which the sleep is likely to be disturbed under the influence of vibration and noise.

The technique described in Japanese Patent Application Laid-open No. 2019-131109 prevents the occurrence of changes in vibration and noise due to electric power generation before and after the start of an occupant's sleep. However, events that disturb sleep are not limited to changes in vibration and noise due to electric power generation. The travel of the vehicle itself may affect a user who is an occupant. Therefore, it is desirable to perform travel control according to a state related to the user's sleep.

The present disclosure has been made in view of the above. It is an object of the present disclosure to provide an information processing device capable of performing travel control of a vehicle according to a state related to a user's sleep.

### SUMMARY OF THE INVENTION

In order to solve the above-described problem and achieve the object, an information processing device according to the present disclosure comprises: an estimation unit to estimate sleep depth of a user riding in a vehicle, using sensor information acquired by a sensor to detect at least one of a state of the user or an environment around the user; and a control information generation unit to generate control information to be used to control travel of the vehicle by automatic driving, using the sleep depth estimated by the estimation unit.

### BRIEF DESCRIPTION OF THE DRAWINGS

FIG. 1 is a diagram illustrating an exemplary configuration of a vehicle according to a first embodiment;

FIG. 2 is a diagram illustrating another exemplary configuration of the first embodiment;

FIG. 3 is a diagram illustrating an exemplary configuration of processing circuitry that implements an information processing device of the first embodiment;

FIG. 4 is a flowchart illustrating an example of a processing procedure in an information processing device of a second embodiment;

FIG. 5 is a conceptual diagram illustrating an example of route setting in the second embodiment;

FIG. 6 is a diagram illustrating an exemplary configuration of a vehicle of the second embodiment in the case where a user setting is received;

FIG. 7 is a flowchart illustrating an example of a processing procedure in the information processing device of the second embodiment in the case where a user setting is received;

FIG. 8 is a flowchart illustrating an example of a processing procedure in an information processing device of a third embodiment;

FIG. 9 is a diagram illustrating an exemplary configuration of a vehicle of the third embodiment that controls devices in the vehicle that affect the environment around a user;

FIG. 10 is a flowchart illustrating an example of a processing procedure in an information processing device of a fourth embodiment;

FIG. 11 is a diagram illustrating an exemplary configuration of a vehicle of the fourth embodiment that estimates a wake-up time using sleep information;

FIG. 12 is a flowchart illustrating an example of a processing procedure in the information processing device of the fourth embodiment that predicts a wake-up time using sleep information;

FIG. 13 is a diagram illustrating an exemplary configuration of a vehicle according to a fifth embodiment;

FIG. 14 is a diagram illustrating an exemplary configuration of an estimation unit of the fifth embodiment in the case where estimation is performed using machine learning; and

FIG. 15 is a schematic diagram illustrating an example of a neural network.

### DETAILED DESCRIPTION OF THE PREFERRED EMBODIMENTS

Hereinafter, an information processing device, a vehicle, a vehicle control method, and a storage medium according to embodiments will be described in detail with reference to the drawings.

### First Embodiment

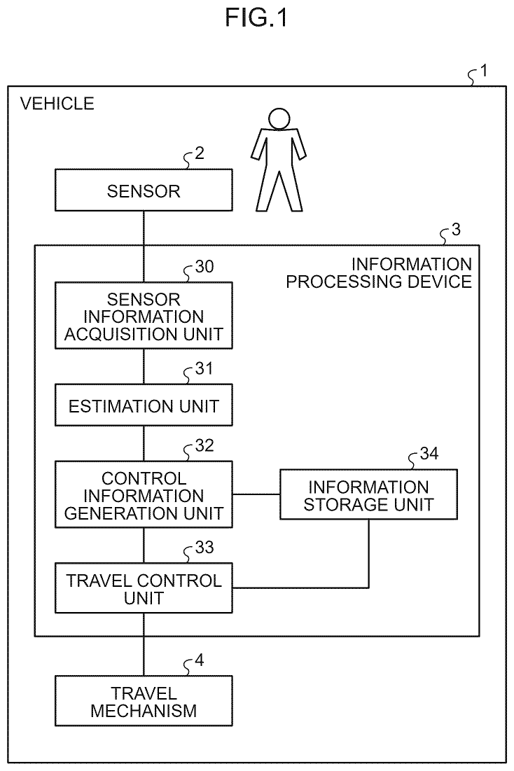

FIG. 1 is a diagram illustrating an exemplary configuration of a vehicle according to a first embodiment. A vehicle 1 of the present embodiment is a self-driving vehicle and includes a sensor 2, an information processing device 3, and a travel mechanism 4. Here, an example in which the vehicle 1 is a self-driving vehicle will be described. The vehicle 1, however, may be capable of switching between automatic driving and manual driving, and may be any vehicle capable of automatic driving.

The sensor 2 is a detection device that detects at least one of the state of a user riding in the vehicle 1 or the environment around the user, and transmits a detection result to the information processing device 3 as sensor information. The sensor information is information indicating at least one of the state of the user riding in the vehicle 1 or the environment around the user. The sensor 2 includes, but is not limited to, for example, at least one of a sensor that acquires vital data of the user, a camera that captures images of the user, a sensor that detects sound, an acceleration sensor attached to the user, an acceleration sensor that detects the acceleration of the vehicle 1, or a sensor attached to the vehicle 1. The vital data includes, but is not limited to, for example, at least one of the heart rate, temperature, blood pressure, or respiratory rate. The sensor 2 that acquires the vital data may be worn by the user, or may be a noncontact sensor or the like fixed to the vehicle 1, or may be other than these. Although FIG. 1 illustrates the single sensor 2, a plurality of sensors 2 may be provided. The number of sensors 2 is not limited to the example illustrated in FIG. 1.

The information processing device 3 includes a sensor information acquisition unit 30, an estimation unit 31, a control information generation unit 32, a travel control unit 33, and an information storage unit 34. The sensor information acquisition unit 30 receives the sensor information from the sensor 2 to acquire the sensor information, and outputs the acquired sensor information to the estimation unit 31. The estimation unit 31 estimates the user's sleep depth, using the sensor information received from the sensor information acquisition unit 30, that is, the sensor information acquired by the sensor 2. For example, the estimation unit 31 estimates whether the user is awake or asleep, using the sensor information, and estimates the user's sleep depth if the user is asleep and notifies the control information generation unit 32 of the estimated sleep depth.

The sleep depth is an index indicating the depth of sleep, and may be indicated, for example, in two stages, REM sleep that is light sleep and non-REM sleep that is sleep deeper than REM sleep, or may be indicated in four or five stages in total by further dividing non-REM sleep into three or four stages. Generally, REM sleep and non-REM sleep occur alternately. Repeated cycles of REM sleep and non-REM sleep are also called sleep cycles. A sleep cycle is, for example, about 90 to 120 minutes. REM sleep is a sleep stage in which sleep is light and rapid eye movements occur. In REM sleep, breathing and pulse are faster, and blood pressure or the like is higher than that in non-REM sleep. Non-REM sleep is sleep deeper than REM sleep. As described above, non-REM sleep is also classified into three or four stages, based on the depth of sleep. For example, when non-REM sleep is classified into four stages from the first stage in which sleep is the lightest in non-REM sleep to the fourth stage in which sleep is the deepest in non-REM sleep, the sleep of a person who has fallen asleep generally proceeds to deeper stages in the order of the first stage, the second stage, the third stage, and the fourth stage of non-REM sleep. REM sleep occurs after the fourth stage of non-REM sleep. After that, REM sleep and non-REM sleep are repeated. However, in the latter half of the sleep, non-REM sleep in lighter stages, that is, the first stage and the second stage increases, and REM sleep also increases.

The estimation unit 31 can estimate, for example, whether the sleep depth is REM sleep or one of the four or three stages of non-REM sleep, using, for example, a sleep parameter that is at least one of the vital data, an index indicating body movement, or the like. Examples of the index indicating body movement include, but are not limited to, the number of times of rolling over, the number of times a specific point has moved by a certain amount or more, and the like. The index indicating body movement is detected, for example, by a camera that captures images of the user, an acceleration sensor attached to the user, a sensor (such as an acceleration sensor or a pressure sensor) attached to the vehicle 1, or the like, which is not limiting. For example, the correspondence between the sleep depth and the numerical range of the sleep parameter is held in a table format as reference information. The estimation unit 31 estimates the sleep depth using the sensor information and the reference information. Alternatively, the relationship between the sleep parameter and the sleep depth may be learned by machine learning. The estimation unit 31 may estimate the sleep depth using learning results and the acquired sleep parameter. Furthermore, the estimation unit 31 may estimate the sleep depth based on the characteristics of changes between REM sleep and the four or three stages of non-REM sleep in a person's typical sleep described above (for example, a standard pattern of repetitions of REM sleep and the four or three stages of non-REM sleep from falling asleep to wake-up).

The third and fourth stages of non-REM sleep are generally deep sleep. During deep sleep, the sleep is insusceptible to external stimuli such as sound, vibration, and light. Even when external stimuli occur, the sleep is unlikely to be disturbed, and sleep rhythm is less affected by the external stimuli. On the other hand, the first and second stages of non-REM sleep are light sleep, and are more susceptible to external stimuli than deep sleep. Events such as the prevention of sleep by external stimuli and the disturbance of sleep rhythm are likely to occur. Although REM sleep can be said to be light sleep from which it is easy to awake, REM sleep is a state that is insusceptible to external stimuli. Therefore, REM sleep can be set as light sleep or deep sleep as appropriate, according to the use of the sleep depth. The definitions of deep sleep and light sleep are not limited to this example, and can be set as appropriate according to the use of the sleep depth.

The sensor information indicating the environment around the user does not directly indicate the state of the user, but may be used to determine whether the surrounding environment is an environment suitable for sleep. For example, the estimation unit 31 can determine whether the environment is not suitable for sleep, using the sensor information indicating the environment around the user, and use the determination result to estimate the sleep depth. For example, as described below, assume that sleep-related travel modes such as a mode to promote sleep and a mode when the user is awake are set, and acceleration is limited in the mode to promote sleep. In this case, the estimation unit 31 can estimate that the mode to promote sleep is set, using the sensor information acquired by the sensor 2 that is an acceleration sensor to detect the acceleration of the vehicle 1, and thus can indirectly ascertain a state related to the user's sleep.

The information storage unit 34 stores map information and route information. The map information may be two-dimensional map information, three-dimensional map information, or a dynamic map also including dynamic information. For the dynamic information of the dynamic map, when it is received, for example, by a communication unit (not illustrated), the dynamic information stored in the information storage unit 34 is updated with the received dynamic information. The route information is information indicating a route of the vehicle 1, and may include the time required to reach a destination (or an estimated time of arrival), an estimated time of arrival at a stopping place, and the like.

Using the sleep depth estimated by the estimation unit 31, the control information generation unit 32 generates control information to be used to control the travel of the vehicle 1 by automatic driving, and outputs the generated control information to the travel control unit 33. The travel control of the vehicle 1 is control of the travel of the vehicle 1 itself, and includes, for example, setting of a movement route, control of the speed of the vehicle 1, control of the acceleration of the vehicle 1, control of handling, control of the stop of the vehicle 1, and the like. For example, the control information generation unit 32 may determine whether or not the user's sleep is deep, using the sleep depth estimated by the estimation unit 31, and generate control information to reduce external stimuli if the sleep is not deep.

A method of reducing external stimuli includes, but is not limited to, for example, at least one of selection of a route (travel route) with fewer external stimuli, prevention of rapid acceleration and deceleration, limitation of speed, gentle handling, or the like. Furthermore, for example, the estimation unit 31 may estimate the sleep depth for a given period of time, using the estimated sleep depth, that is, predict the sleep depth for a given period of time, and notify the control information generation unit 32 of the result of the estimation of the sleep depth for the given period of time. In this case, the control information generation unit 32 may set a route that allows the user to wake up as naturally as possible at a point where the user should wake up, using the sleep depth for the given period of time. The given period of time is a period in the future, for example, a period of time from the current point of time. The point where the user should wake up may be the destination of the user or a place where the user is scheduled to stop off on the way.

The control information generation unit 32 may switch a mode of travel (hereinafter also referred to as a travel mode), using the sleep depth for the given period of time. For example, the control information generation unit 32 may switch the travel mode in such a manner as to switch the travel mode to normal travel (a normal travel mode) with no particular restrictions if the user is awake, not asleep, switch the travel mode to a limited travel mode in which limits are imposed to achieve gentler travel if the user's sleep is light, and switch the travel mode to the normal travel mode if the user's sleep is deep. Gentler travel is travel that reduces external stimuli to the user. The definitions and method of switching of the travel modes are not limited to this example. In the case where the control information generation unit 32 generates control information on the route, the control information generation unit 32 may further use the map information stored in the information storage unit 34 to generate the control information.

In addition to the control information to control travel, the control information generation unit 32 may generate control information to control devices (not illustrated) in the vehicle 1 to control the devices. For example, the control information generation unit 32 may control devices such as a seat, equipment to adjust illumination, a device to generate sound such as music or environmental sound, and a massage apparatus provided on a seat in the vehicle 1, according to the sleep depth. For example, in the case where the sleep is light, the control information generation unit 32 may perform control to gently tilt the seat to promote the user's sleep, or may perform control to reduce the volume of the device that generates sound. In the case where the time required to reach the destination is long, before the user falls asleep, the control information generation unit 32 may perform control to promote the user's falling asleep. For example, the control information generation unit 32 may operate the massage apparatus or play music for relaxation to promote falling asleep. Further, to promote falling asleep, the control information generation unit 32 may set the above-described travel mode to the limited travel mode.

Whether or not to perform control to promote falling asleep may be able to be set by the user. Furthermore, for example, the control information generation unit 32 may set a wake-up time desired by the user, determine the timing to fall asleep by calculating backwards from the set wake-up time so that the user will be in REM sleep or light-sleep non-REM sleep at the wake-up time, and start promotion of falling asleep before the determined timing so that the user can easily fall asleep at the determined timing or a time close to the determined timing. Alternatively, the control information generation unit 32 may set the wake-up time to an expected time of arrival at the destination, determine the timing to fall asleep so that the user can easily wake up near the destination, and perform control to promote falling asleep likewise.

The travel control unit 33 controls the travel of the vehicle 1 by automatic driving. The travel control unit 33 performs travel control of the vehicle 1 by controlling the travel mechanism 4, based on information acquired by a sensor (not illustrated) such as a camera, a light detection and ranging (LiDAR), or a millimeter-wave sensor that detects obstacles, the map information stored in the information storage unit 34, and the self-position calculated by a self-position estimation device that estimates the self-position (not illustrated). For example, when a destination is set by the user or another operator or the like, the travel control unit 33 sets a route to the set destination using the destination and the map information, and controls the travel mechanism 4 to travel along the set route. The travel control unit 33 stores route information indicating the set route in the information storage unit 34. The travel control unit 33 may also calculate the time required to reach the destination (or an estimated time of arrival) and an estimated time of arrival at a stopping place, and include these in the route information. The travel control unit 33 may set the route using dynamic information on roads and traffic such as congestion information and obstacle information. Automatic driving travel control may be performed with any method and can use a typical method, and thus will not be described in detail.

When receiving control information from the control information generation unit 32, the travel control unit 33 controls the travel mechanism 4, based on the received control information. Here, an example in which the travel control unit 33 sets a route will be described. Alternatively, the control information generation unit 32 may set a route and notify the travel control unit 33 of the set route as control information, and the travel control unit 33 may control the travel mechanism 4 according to the route based on the control information.

The travel mechanism 4 is a mechanism to cause the vehicle 1 to travel, and includes, for example, a plurality of mechanisms to cause the vehicle 1 to travel, including an accelerator operation device such as an accelerator pedal, a steering device, and a brake.

In the present embodiment, the information processing device 3 estimates the user's sleep depth, and generates control information to control the travel of the vehicle 1, based on the estimated sleep depth. This allows the vehicle 1 to perform travel control of the vehicle 1 according to a state related to the user's sleep. Consequently, the vehicle 1 can make the environment of the user due to the acceleration, deceleration, and handling in the travel of the vehicle 1 and the route to be traveled by the vehicle 1 suitable for the user's sleep depth. Furthermore, the vehicle 1 can perform control so that the time at which the user should wake up will be in REM sleep or light-sleep non-REM sleep, to allow the user's natural wake-up.

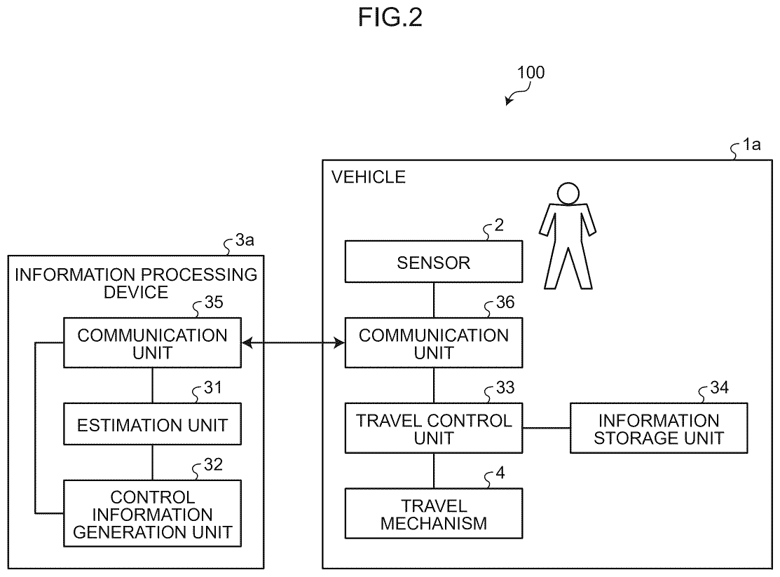

In the example described above, the information processing device 3 is provided in the vehicle 1. However, an information processing device may be provided separately from a vehicle. FIG. 2 is a diagram illustrating another exemplary configuration of the present embodiment. In the example illustrated in FIG. 2, a vehicle system 100 includes an information processing device 3a and a vehicle 1a. Components having the same functions as those in the example illustrated in FIG. 1 are denoted by the same reference numerals as those in FIG. 1 to omit redundant descriptions. The information processing device 3a is provided separately from the vehicle 1a. A communication unit 35 capable of communicating with the vehicle 1a is added instead of the sensor information acquisition unit 30 of the information processing device 3 illustrated in FIG. 1. The communication unit 35 receives the sensor information and thus also has a function as a sensor information acquisition unit that acquires the sensor information. The travel control unit 33 in the information processing device 3 illustrated in FIG. 1 is provided in the vehicle 1a.

The vehicle 1a is obtained by deleting the information processing device 3 from the vehicle 1 illustrated in FIG. 1, and adding a communication unit 36 capable of communicating with the information processing device 3a. A communication line between the vehicle 1a and the information processing device 3a includes, for example, a wireless communication line, but may be a combination of a wireless communication line and a wired communication line. Communication between the vehicle 1a and the information processing device 3a may be performed via another device.

The communication unit 36 of the vehicle 1a receives the sensor information from the sensor 2 and transmits the received sensor information to the information processing device 3a. The communication unit 35 of the information processing device 3a receives the sensor information from the vehicle 1a and outputs the received sensor information to the estimation unit 31. The operations of the estimation unit 31 and the control information generation unit 32 are the same as those in the example illustrated in FIG. 1, but the control information generation unit 32 outputs generated control information to the communication unit 35. The communication unit 35 transmits the control information received from the control information generation unit 32 to the vehicle 1a. Upon receiving the control information from the information processing device 3a, the communication unit 36 of the vehicle 1a outputs the received control information to the travel control unit 33. The travel control unit 33, the information storage unit 34, and the travel mechanism 4 are the same as those in the example illustrated in FIG. 1.

In the case where the control information generation unit 32 generates control information on a route, the information processing device 3a may further include the information storage unit 34 and generate the control information using the map information stored in the information storage unit 34.

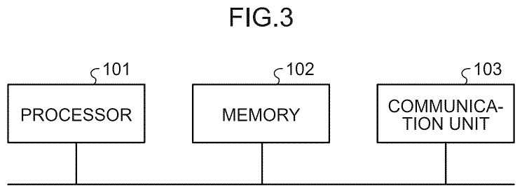

Next, a hardware configuration of the information processing device 3 of the present embodiment will be described. For the information processing device 3 of the present embodiment, a program (computer program) in which processing in the information processing device 3 is described is executed on a computer system so that the computer system functions as the information processing device 3. The computer system includes, for example, processing circuitry. FIG. 3 is a diagram illustrating an exemplary configuration of processing circuitry that implements the information processing device 3 of the present embodiment. As illustrated in FIG. 3, the processing circuitry includes a processor 101, a memory 102, and a communication unit 103. The processing circuitry may be a single circuit or a plurality of circuits. These are connected via a system bus. The communication unit 103 may be provided separately from the processing circuitry. The computer system that implements the information processing device 3 may further include at least one of an input unit such as buttons or a keyboard to receive input, or a display unit such as a display or a monitor.

In FIG. 3, the processor 101 is, for example, a control unit such as a central processing unit (CPU), and executes the program in which processing in the information processing device 3 of the present embodiment is described. The memory 102 includes various types of memory such as random-access memory (RAM) and read-only memory (ROM) and a storage device such as a hard disk, and stores the program to be executed by the processor 101, necessary data obtained during processing, etc. The memory 102 is also used as a temporary storage area for the program. The communication unit 103 is a receiver and a transmitter that perform communication processing.

Here, an example of operation of the computer system before the program of the present embodiment becomes executable will be described. In the computer system having the above-described configuration, the program is installed in the memory 102, for example, from a compact disc (CD)-ROM or a digital versatile disc (DVD)-ROM set in a CD-ROM drive or a DVD-ROM drive (not illustrated). At the time of execution of the program, the program read from the memory 102 is stored in the main storage area of the memory 102. In this state, the processor 101 performs processing as the information processing device 3 of the present embodiment, according to the program stored in the memory 102.

In the above description, the program describing the processing in the information processing device 3 is provided using the CD-ROM or DVD-ROM as a recording medium, which is not limiting. For example, the program provided through a transmission medium such as the Internet via the communication unit 103 may be used, depending on the configuration of the computer system, the size of the provided program, etc.

The program of the present embodiment causes, for example, a computer system that controls the vehicle 1 to perform a step of estimating a user's sleep depth, using sensor information acquired by the sensor 2, and a step of generating control information to be used to control the travel of the vehicle 1 by automatic driving, using the estimated sleep depth.

The estimation unit 31, the control information generation unit 32, and the travel control unit 33 illustrated in FIG. 1 are implemented by the processor 101 illustrated in FIG. 3 executing the program stored in the memory 102 illustrated in FIG. 3. The memory 102 illustrated in FIG. 3 is also used to implement the estimation unit 31, the control information generation unit 32, and the travel control unit 33 illustrated in FIG. 1. The sensor information acquisition unit 30 illustrated in FIG. 1 is implemented by the communication unit 103 illustrated in FIG. 3. The information storage unit 34 illustrated in FIG. 1 is part of the memory 102 illustrated in FIG. 3.

The information processing device 3a illustrated in FIG. 2 is likewise implemented by a computer system including the processing circuitry illustrated in FIG. 3. The computer system that implements the information processing device 3a may further include at least one of an input unit or a display unit in addition to the processing circuitry. The communication unit 35 illustrated in FIG. 2 is implemented by the communication unit 103 illustrated in FIG. 3. The information processing device 3a may be implemented by a plurality of computer systems. For example, the information processing device 3a illustrated in FIG. 2 may be implemented by a cloud system.

### Second Embodiment

A second embodiment describes an example of travel control of the vehicle 1 with the information processing device 3 described in the first embodiment. The configuration of the vehicle 1 of the present embodiment is the same as that of the first embodiment. Here, a configuration in which the information processing device 3 is provided in the vehicle 1 as illustrated in FIG. 1 of the first embodiment will be described as an example. However, the operation of the present embodiment can also be applied to the exemplary configuration illustrated in FIG. 2 of the first embodiment. Components having the same functions as those of the first embodiment are denoted by the same reference numerals as those of the first embodiment to omit redundant descriptions.

In the present embodiment, the information processing device 3 sets a route to a destination so that the vehicle 1 will arrive at a parking place such as a service area (SA) and be parked during a time when a user riding in the vehicle 1 is in light sleep, and then resume travel. Consequently, the information processing device 3 can prevent the occurrence of stimuli to the user due to the travel of the vehicle 1 during a light-sleep time, and can promote the user's deep sleep.

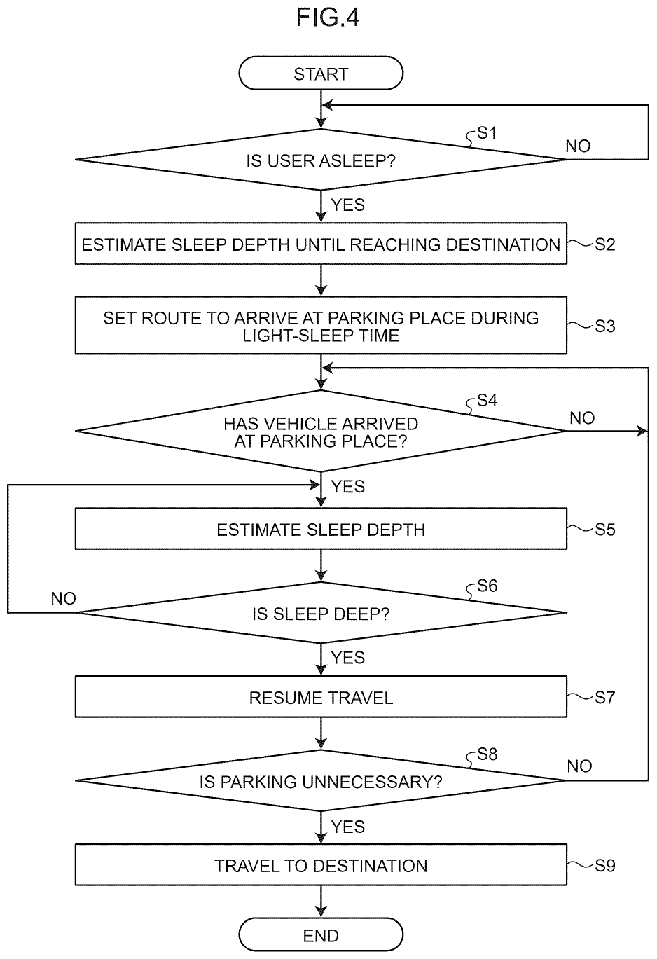

FIG. 4 is a flowchart illustrating an example of a processing procedure in the information processing device 3 of the present embodiment. As illustrated in FIG. 4, the information processing device 3 determines whether or not the user is asleep (step S1). In the present embodiment, the sensor information acquisition unit 30 acquires sensor information from the sensor 2 periodically, for example.

Specifically, in step S1, the estimation unit 31 determines whether or not the user riding in the vehicle 1 is asleep, using the sensor information received from the sensor information acquisition unit 30. For example, a camera is used as the sensor 2, and whether the user is asleep or not is determined using captured-image data obtained by the camera capturing images of the user. For example, the estimation unit 31 may detect the movement of the user, based on the captured-image data that is the sensor information, and determine whether or not the user is asleep, based on the movement of the user, or may determine whether or not the user's eyelids are closed, based on the captured-image data, and determine whether or not the user is asleep, based on the result of the determination of whether or not the eyelids are closed. Alternatively, an acceleration sensor worn by the user may be used as the sensor 2, and the estimation unit 31 may determine whether or not the user is asleep, based on the sensor information that is the result of detection with the acceleration sensor. Alternatively, a sensor that acquires vital data may be used as the sensor 2, and the estimation unit 31 may determine whether or not the user is asleep, based on the sensor information that is the vital data. Alternatively, the estimation unit 31 may determine whether or not the user is asleep, using a combination of the captured-image data and the vital data. A method of determining whether or not the user is asleep is not limited to these examples.

If the user is not asleep (No in step S1), step S1 is repeated. If the user is asleep (Yes in step S1), the information processing device 3 estimates the sleep depth until reaching the destination (step S2). Specifically, the estimation unit 31 extracts the route to the destination and the time required to reach the destination from the route information stored in the information storage unit 34, estimates the sleep depth at each time from the current time to the time of arrival at the destination, using the extracted information, and outputs the estimated sleep depth to the control information generation unit 32. The route to the destination and the time required to reach the destination are calculated, for example, by the travel control unit 33 and stored in the information storage unit 34 as route information as described in the first embodiment. Alternatively, as described in the first embodiment, the control information generation unit 32 may set a route using the destination and the map information and determine the required time. In this case, the control information generation unit 32 stores route information in the information storage unit 34. Here, an example in which the estimation unit 31 estimates the sleep depth until reaching the destination will be described, which is not limiting. The estimation unit 31 only needs to estimate the sleep depth for a given period of time ahead. As described above, the given period of time may be the time required to reach the destination, a time shorter than the time required to reach the destination, such as half the time required to reach the destination, or a predetermined period of time.

Next, the information processing device 3 sets a route to arrive at a parking place during a light-sleep time (step S3). Specifically, the control information generation unit 32 determines a period during which the user's sleep is predicted to be light, using the sleep depth until reaching the destination estimated by the estimation unit 31, determines the route of the vehicle 1 so that the vehicle 1 will arrive at a parking place within the determined period, and generates control information indicating the determined route. The control information may be output to the travel control unit 33 or may be stored in the information storage unit 34 as route information.

For example, the control information generation unit 32 first calculates the position of the vehicle 1 during a light-sleep time period, using the route to the destination and the sleep depth until reaching the destination received from the estimation unit 31. If there is a parking place around the calculated position, the control information generation unit 32 determines a route so that the vehicle 1 will arrive at the parking place and be parked in the parking place during that time period. The parking place includes, for example, at least one of an SA or a parking area (PA). The parking place may include a rest area such as a roadside station, or may include a parking lot where parking is permitted. The parking lot may be a parking lot of a store, a park, or the like. If there is a parking place on an initially set route, the control information generation unit 32 may determine the travel speed so that the vehicle 1 will arrive at the parking place during the light-sleep time period, and also output the determined travel speed to the travel control unit 33 as control information. If there is no parking place on an initially set route, the control information generation unit 32 selects a parking place at which the vehicle 1 will arrive during the light-sleep time period among parking places around the route, and sets a route passing through the parking place. That is, the control information generation unit 32 updates the route information stored in the information storage unit 34 to route information (control information) indicating the route passing through the parking place. Alternatively, the control information generation unit 32 may output the route information indicating the route passing through the parking place to the travel control unit 33 as control information. The control information generation unit 32 generates control information to park the vehicle 1 in the parking place, and outputs the generated control information to the travel control unit 33. An instruction to park the vehicle 1 in the parking place may be included in the route information. Consequently, the travel control unit 33 controls the travel of the vehicle 1, based on the updated route information. When the vehicle 1 arrives at the parking place, the travel control unit 33 controls the travel mechanism 4 to park the vehicle 1 in the parking place.

In the case where it is estimated that a predetermined number or more of light-sleep times will appear before arrival at the destination, assuming that travel is resumed after parking in a parking place for a given period of time, the control information generation unit 32 may determine parking places corresponding one-to-one to two or more of the light-sleep times, and set a route passing through the determined two or more parking places. For example, in the case where the time required to reach the destination is seven hours or more, four or five sleep cycles will occur. However, since sleep cycles in the latter half are preparation for awakening, the control information generation unit 32 may set a route passing through two parking places to promote deep sleep in sleep cycles up to the second cycle in the first half.

Next, the information processing device 3 determines whether or not the vehicle 1 has arrived at the parking place (step S4). Specifically, the control information generation unit 32 may determine that the vehicle 1 has arrived at the parking place when the control information generation unit 32 receives a notification that the vehicle 1 has been parked in the parking place from the travel control unit 33, or may determine that the vehicle 1 has arrived at the parking place when the control information generation unit 32 acquires the current position of the vehicle 1 from the travel control unit 33 and the current position is in the parking place.

If the vehicle 1 has not arrived at the parking place (No in step S4), step S4 is repeated. If the vehicle 1 has arrived at the parking place (Yes in step S4), the information processing device 3 estimates the sleep depth (step S5). Specifically, the control information generation unit 32 instructs the estimation unit 31 to estimate the sleep depth, and the estimation unit 31 estimates the current sleep depth of the user using the sensor information and outputs the estimation result to the control information generation unit 32.

The information processing device 3 determines whether or not the sleep is deep (step S6). Specifically, the control information generation unit 32 determines whether or not the user's sleep is deep, based on the estimation result received from the estimation unit 31.

If the sleep is not deep (No in step S6), the processing from step S5 is repeated. If the sleep is deep (Yes in step S6), the information processing device 3 resumes travel (step S7). Specifically, the control information generation unit 32 generates control information indicating the resumption of travel, and outputs the generated control information to the travel control unit 33. The travel control unit 33 controls the travel mechanism 4 to resume the travel of the vehicle 1, based on the control information received from the control information generation unit 32. As described above, after the vehicle 1 has arrived at the parking place, the control information generation unit 32 that has determined that the user's sleep is deep, using the result of estimation of the sleep depth estimated by the estimation unit 31 based on the sensor information, generates control information indicating causing the vehicle 1 to depart from the parking place and resume travel.

After the resumption of travel, the information processing device 3 determines whether or not parking is unnecessary (step S8). Specifically, in the case where the vehicle 1 has already been parked in all parking places through which to pass on the route indicated by the route information, the control information generation unit 32 determines that parking is unnecessary. Even if there is a parking place in which the vehicle 1 has not been parked yet among all parking places through which to pass on the route indicated by the route information, in the case where it is expected that travel will take more time than initially scheduled and arrival at the destination will be delayed by a predetermined time or more, the control information generation unit 32 may determine that parking is unnecessary in step S8 even if there is a parking place in which the vehicle 1 has not been parked yet.

If parking is not unnecessary (No in step S8), the processing from step S4 is repeated. If parking is unnecessary (Yes in step S8), the information processing device 3 causes the vehicle 1 to travel to the destination (step S9). Specifically, in step S9, in the case where the vehicle 1 has already been parked in all parking places through which to pass, the travel control unit 33 controls the travel mechanism 4 to cause the vehicle 1 to travel to the destination, based on the route information. In the case where there is a parking place in which the vehicle 1 has not been parked yet, but the information processing device 3 determines in step S8 that parking is unnecessary, in step S9, the control information generation unit 32 sets a route that does not pass through a remaining parking place(s) that has/have been scheduled to be passed through (a parking place(s) at which the vehicle 1 has not arrived yet). That is, the control information generation unit 32 updates the route information stored in the information storage unit 34 to route information indicating the route not passing through the remaining parking place(s). Consequently, the travel control unit 33 controls the travel of the vehicle 1 based on the updated route information to cause the vehicle 1 to travel to the destination.

In the example illustrated in FIG. 4, the information processing device 3 causes the vehicle 1 that has been parked in a parking place to resume travel after the user's sleep becomes deep, which is not limiting. The information processing device 3 may cause the vehicle 1 that has been parked in a parking place for a predetermined period of time to resume travel. Alternatively, the information processing device 3 may cause the vehicle 1 to resume travel when at least one of the condition that the user's sleep becomes deep or the condition that the vehicle 1 has been parked in a parking place for a predetermined period of time is satisfied.

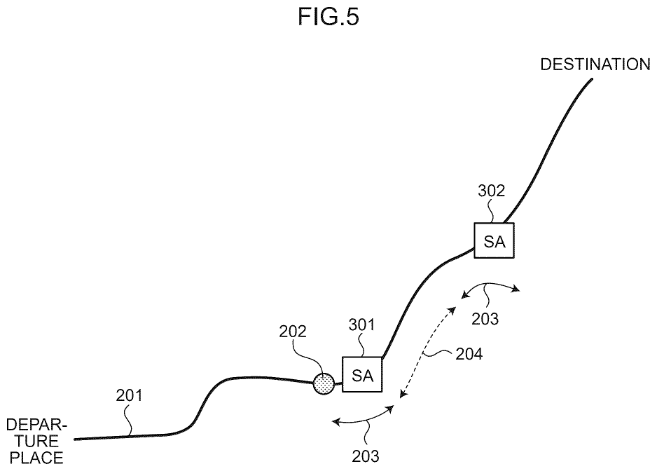

FIG. 5 is a conceptual diagram illustrating an example of route setting in the present embodiment. In the example illustrated in FIG. 5, a route 201 from a departure place to a destination is set. Assume that the user has fallen asleep at a point 202 on the route 201 after the vehicle 1 has left the departure place. In the example illustrated in FIG. 5, the information processing device 3 predicts the user's sleep depth, determines that the user's sleep will be light during a time (period) when the vehicle 1 is traveling in a section 203, and sets the route 201 so as to pass through an SA 301 and an SA 302. A section 204 is a section corresponding to a time (period) during which the user's sleep will be deep. Thus, the vehicle 1 is parked in parking places such as the SAs 301 and 302 during the times when the user's sleep is light, so that it is possible to prevent stimuli to the user due to the travel of the vehicle 1 to promote the user's deep sleep. Note that FIG. 5 is an example, and the set route and the number of parking places are not limited to the example illustrated in FIG. 5. The parking places are not limited to SAs, and may be PAs as described above, or may be parking lots in stores, parks, and the like.

In the example described above, the user's deep sleep is promoted by parking the vehicle 1 in the parking places. However, it is conceivable that the user may wish to get out of the vehicle 1 in a parking place to take a toilet break or do some shopping in the parking place. Therefore, the user may be allowed to set whether to promote deep sleep or awaken the user in a parking place.

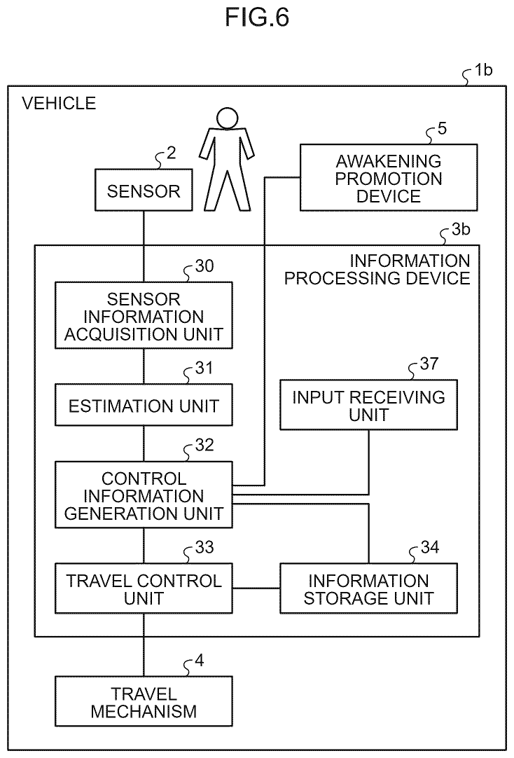

FIG. 6 is a diagram illustrating an exemplary configuration of a vehicle of the present embodiment in the case where a user setting is received. A vehicle 1b illustrated in FIG. 6 is the same as the vehicle 1 illustrated in FIG. 1 except that an awakening promotion device 5 is added and an information processing device 3b is provided instead of the information processing device 3. Components having the same functions as those in the example illustrated in FIG. 1 are denoted by the same reference numerals as those in FIG. 1 to omit redundant descriptions.

As illustrated in FIG. 6, the information processing device 3b is the information processing device 3 illustrated in FIG. 1 to which an input receiving unit 37 has been added. The input receiving unit 37 receives, from the user, input of a selection result of the user's selection of whether or not to get out of the vehicle 1 at a parking place. The input receiving unit 37 outputs the received selection result to the control information generation unit 32. In the case where the selection result indicates that the user will get out of the vehicle 1 at the parking place, the control information generation unit 32 sets an operation mode in the parking place to awakening promotion. In the case where the operation mode in the parking place is set to awakening promotion, when the vehicle 1 arrives at the parking place, the control information generation unit 32 generates control information indicating the user's awakening, and outputs the generated control information to the awakening promotion device 5. Upon receiving the control information from the control information generation unit 32, the awakening promotion device 5 performs an operation to promote the user's awakening. The operation to promote the user's awakening may be, for example, an operation to generate a sound such as a voice, an alarm, or music to announce the arrival at the parking place, an operation to vibrate the seat, or other than these. In the case where the selection result indicates that the user will not get out of the vehicle 1 at the parking place, the control information generation unit 32 sets the operation mode in the parking place to sleep promotion, and does not perform control to awaken the user even when the vehicle 1 arrives at the parking place, as in the example illustrated in FIG. 4.

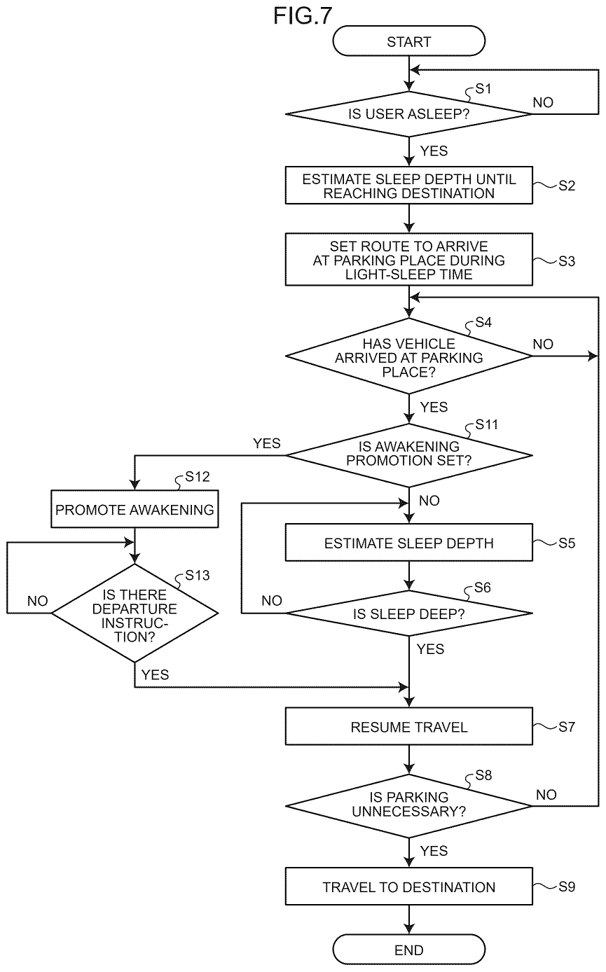

FIG. 7 is a flowchart illustrating an example of a processing procedure in the information processing device 3b of the present embodiment in the case where a user setting is received. Steps S1 to S4 are the same as those in the example illustrated in FIG. 4. If Yes in step S4, the information processing device 3b determines whether or not awakening promotion is set (step S11). Specifically, the control information generation unit 32 determines whether or not the operation mode in the parking place is awakening promotion. If awakening promotion is not set (No in step S11), steps S5 to S9 are performed as in FIG. 4.

If awakening promotion is set (Yes in step S11), the information processing device 3b promotes the user's awakening (step S12). Specifically, the control information generation unit 32 generates control information indicating the user's awakening, and outputs the generated control information to the awakening promotion device 5. Thus, upon receiving the control information from the control information generation unit 32, the awakening promotion device 5 performs the operation to promote the user's awakening.

Next, the information processing device 3b determines whether or not there is a departure instruction, that is, an instruction to the vehicle 1b to depart (step S13). If there is a departure instruction (Yes in step S13), the information processing device 3b causes the process to proceed to step S7. If there is no departure instruction (No in step S13), the information processing device 3b repeats step S13. An instruction to the vehicle 1b to depart is input, for example, by the user. When receiving input of an instruction to the vehicle 1b to depart from the user, the input receiving unit 37 outputs information indicating that an instruction to the vehicle 1b to depart has been given to the control information generation unit 32. In step S13, the control information generation unit 32 determines whether or not there is a departure instruction, based on whether or not information indicating that an instruction to the vehicle 1b to depart has been given has been received from the input receiving unit 37.

In the example illustrated in FIG. 7, if the operation mode is set to sleep promotion, the same processing as that in FIG. 4 is performed, and if the operation mode is set to awakening promotion, the user's awakening is promoted when the vehicle 1b arrives at the parking place. Even when the user's awakening is promoted in the parking place, the user is easily awakened naturally since the route is set so that the vehicle 1b will arrive at the parking place during the light-sleep time. In the example illustrated in FIG. 7, since the user can set the operation mode, the information processing device 3b can perform operation according to the user's request. The input receiving unit 37 and the awakening promotion device 5 may be added to the vehicle 1a illustrated in FIG. 2 of the first embodiment, and information received by the input receiving unit 37 may be transmitted to the information processing device 3a via the communication unit 36 so that the information processing device 3a performs the same process as the process illustrated in FIG. 7.

In the example illustrated in FIGS. 6 and 7, the vehicle 1b includes the awakening promotion device 5, but the awakening promotion device 5 may not be provided in the vehicle 1b. When the vehicle 1b arrives at a parking place during a light-sleep time, the user may feel the arrival by himself/herself and wake up naturally. Therefore, the information processing device 3b may wait for the user to get out of the vehicle 1b for a given period of time after arriving at a parking place. In the case where the user does not wake up even after a lapse of the given period of time, the information processing device 3b may perform an operation when the operation mode is set to sleep promotion.

The information processing device 3b illustrated in FIG. 6 is implemented, for example, by the processing circuitry illustrated in FIG. 3 and an input unit (not illustrated). The input receiving unit 37 is implemented by the input unit.

As described above, in the present embodiment, the route of the vehicle 1 or 1b is set so that the vehicle 1 or 1b will arrive at a parking place during a light-sleep time, and the vehicle 1 or 1b that has arrived at the parking place is stopped at the parking place. Consequently, the vehicle 1 or 1b can prevent sleep from being disturbed under stimuli due to the travel of the vehicle 1 or 1b during a light-sleep time, promoting the user's deep sleep. That is, it is possible to perform travel control according to a state related to the user's sleep.

### Third Embodiment

Like the second embodiment, a third embodiment describes an example of travel control of the vehicle 1 with the information processing device 3 described in the first embodiment. The configuration of the vehicle 1 of the present embodiment is the same as that of the first embodiment. Here, a configuration in which the information processing device 3 is provided in the vehicle 1 as illustrated in FIG. 1 of the first embodiment will be described as an example. However, the operation of the present embodiment can also be applied to the exemplary configuration illustrated in FIG. 2 of the first embodiment. Components having the same functions as those of the first embodiment are denoted by the same reference numerals as those of the first embodiment to omit redundant descriptions.

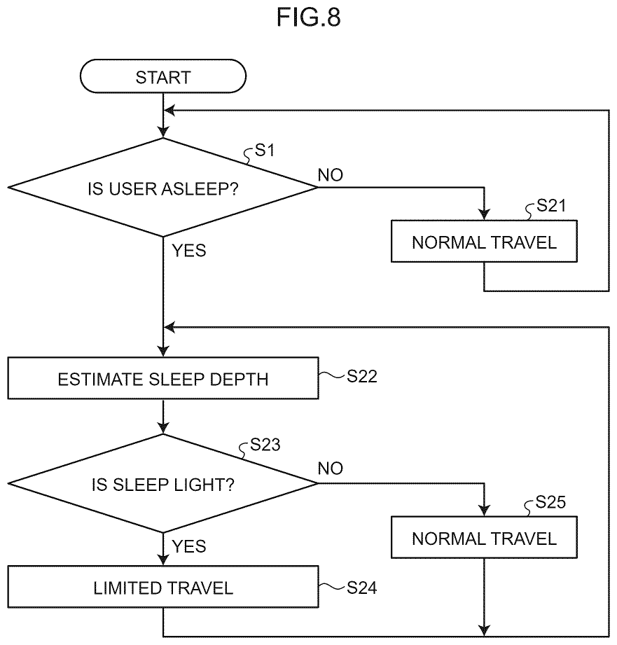

FIG. 8 is a flowchart illustrating an example of a processing procedure in the information processing device 3 of the present embodiment. As illustrated in FIG. 8, the information processing device 3 determines whether or not the user is asleep as in step S1 of the second embodiment. Also in the present embodiment, the sensor information acquisition unit 30 acquires the sensor information from the sensor 2 periodically, for example.

If the user is not asleep (No in step S1), the information processing device 3 decides to set the travel of the vehicle 1 to normal travel (step S21), and step S1 is repeated. For example, as described in the first embodiment, for the travel mode of the vehicle 1, the user can set two types of mode, the normal travel mode and the limited travel mode. The control information generation unit 32 sets the travel mode to the normal travel mode. In the case where the travel mode is already set to the normal travel mode, the travel mode does not need to be changed. The control information generation unit 32 sets the travel mode to the normal travel mode without change.

When the user is asleep (Yes in step S1), the information processing device 3 estimates the sleep depth (step S22). Specifically, the estimation unit 31 estimates the current sleep depth of the user using the sensor information, and outputs the estimation result to the control information generation unit 32. Alternatively, the estimation unit 31 may predict the sleep depth for a given period of time ahead, using the estimation result of the current sleep depth of the user, and also output the prediction result to the control information generation unit 32.

Next, the information processing device 3 determines whether or not the sleep is light (step S23). Specifically, the control information generation unit 32 determines whether or not the user's sleep is light, based on the estimation result received from the estimation unit 31. If the sleep is light (Yes in step S23), the information processing device 3 decides to set the travel of the vehicle 1 to limited travel (step S24), and repeats the processing from step S22. Specifically, in step S24, the control information generation unit 32 generates control information to make the travel of the vehicle 1 gentler travel than in normal times without limits. For example, the control information generation unit 32 sets the travel mode to the limited travel mode. In the case where the travel mode is already set to the limited travel mode, the travel mode does not need to be changed. The control information generation unit 32 generates control information indicating the setting of the travel mode to the limited travel mode without change, and outputs the generated control information to the travel control unit 33. In the limited travel mode, as described in the first embodiment, travel control is performed to achieve gentler travel.

Specifically, in the limited travel mode, a limit may be imposed by setting at least one of speed or acceleration to be lower than or equal to a threshold value, or the travel route may be set to a route that allows gentler travel. Examples of the route that allows gentler travel include, but are not limited to, a route with fewer sharp curves, a route with less unevenness on the road surface, and a route with a gentler slope. For example, assume that numerical values indicating the curvature of curves, the unevenness of road surfaces, and the slopes of roads are included in the map information. The control information generation unit 32 can judge a curve whose curvature is higher than or equal to a threshold value as a sharp curve, judge a route with a numerical value indicating the unevenness of the road surface lower than or equal to a threshold value as a route with little unevenness, and judge a route with a numerical value indicating the slope of the road lower than or equal to a threshold value as a route with a gentle slope. As described above, the control information generation unit 32 may receive the predicted value of the sleep depth for the given period of time ahead from the estimation unit 31. In this case, the control information generation unit 32 sets the travel mode during a period when the sleep is light in the prediction result to the limited travel mode.

If the sleep is not light (No in step S23), the information processing device 3 decides to set the travel of the vehicle 1 to normal travel (step S25), and repeats the processing from step S22. Specifically, in step S25, for example, the control information generation unit 32 sets the travel mode to the normal travel mode. In the case where the travel mode is already set to the normal travel mode, the travel mode does not need to be changed. The control information generation unit 32 sets the travel mode to the normal travel mode without change.

By performing the process illustrated in FIG. 8, the information processing device 3 can perform control to allow gentler travel during a time when the user's sleep is light. That is, it is possible to perform travel control according to a state related to the user's sleep. In the above-described example, the vehicle 1 is made to travel gently during a time when the user's sleep is light so as not to disturb the user's sleep. Further, during a time when the user's sleep is light, external stimuli to the user due to factors other than travel may be reduced. For example, by adjusting at least one of ambient brightness or ambient sound as the environment around the user, an external stimuli may be reduced. For example, in step S24 described above, the control information generation unit 32 may set a route avoiding well-lighted places or a route avoiding noisy places. The route avoiding well-lighted places is, for example, a route avoiding areas with many stores when the vehicle 1 travels at night, but is not limited thereto. The route avoiding noisy places is, for example, a route avoiding areas around construction sites or a route avoiding places with many people or cars, but is not limited thereto.

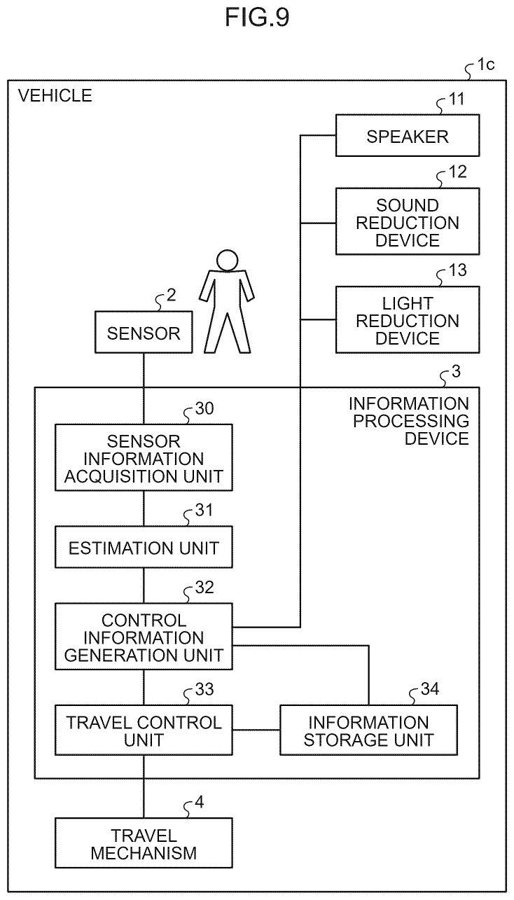

The control information generation unit 32 may control devices in the vehicle 1 that affect the environment around the user, to reduce external stimuli to the user. FIG. 9 is a diagram illustrating an exemplary configuration of a vehicle of the present embodiment that controls devices in a vehicle 1c that affect the environment around the user. The vehicle 1c illustrated in FIG. 9 is the vehicle 1 of the first embodiment to which a speaker 11, a sound reduction device 12, and a light reduction device 13 have been added.

The speaker 11 outputs audio data output from an audio data output device (not illustrated) as a sound. The audio data output device is, for example, a device that reproduces music or the like in the vehicle 1c, a device that acquires audio data broadcasted or distributed, or the like. The sound reduction device 12 is a device that reduces sound in the vehicle 1c, and may be a combination of a sound-absorbing sheet and a device that controls the ejection and retraction of the sound-absorbing sheet, or a device that performs noise canceling by detecting noise in the vehicle 1c and generating a sound with a phase opposite to that of the detected noise to cancel the noise by electrical processing, or may be other than these. The light reduction device 13 is a device that reduces light in the vehicle 1c, and may be, for example, light-control films capable of adjusting the transmittance of light, provided on windows in the rear of the vehicle 1c or the like, or curtains or the like that block light while the vehicle 1c is parked, or may be other than these.

In the example illustrated in FIG. 9, in step S24 illustrated in FIG. 8, the control information generation unit 32 further generates control information to operate the speaker 11, the sound reduction device 12, and the light reduction device 13, and outputs the generated control information to the speaker 11, the sound reduction device 12, and the light reduction device 13, thereby reducing sound and light in the vehicle 1. For example, the control information generation unit 32 generates control information to reduce the volume of the speaker 11 or turn off the speaker 11, generates control information to cause the sound reduction device 12 to reduce sound in the vehicle 1, and generates control information to cause the light reduction device 13 to reduce light in the vehicle 1. This can prevent the occurrence of not only stimuli due to travel but also stimuli due to the surrounding environment other than travel to the user. In the example illustrated in FIG. 9, an example in which the vehicle 1c includes the speaker 11, the sound reduction device 12, and the light reduction device 13 has been described, which is not limiting. The vehicle 1c may include one or two of the speaker 11, the sound reduction device 12, and the light reduction device 13.

The speaker 11, the sound reduction device 12, and the light reduction device 13 may be added to the vehicle 1a illustrated in FIG. 2 of the first embodiment. The information processing device 3a may generate control information to control these devices and transmit the control information to the vehicle 1a via the communication unit 35. Also in this case, the vehicle 1a may include one or two of the speaker 11, the sound reduction device 12, and the light reduction device 13.

The information processing device 3 may perform both the operation of the second embodiment and the operation described in the present embodiment. The vehicle 1a and the information processing device 3a illustrated in FIG. 2 may perform both the operation of the second embodiment and the operation described in the present embodiment.

Here, an example of reducing both stimuli due to travel and stimuli due to the environment around the user has been described. However, the vehicle 1c may reduce only stimuli due to the environment around the user when the user's sleep is light.

### Fourth Embodiment

Like the second and third embodiments, a fourth embodiment describes an example of travel control of the vehicle 1 with the information processing device 3 described in the first embodiment. The configuration of the vehicle 1 of the present embodiment is the same as that of the first embodiment. Here, a configuration in which the information processing device 3 is provided in the vehicle 1 as illustrated in FIG. 1 of the first embodiment will be described as an example. However, the operation of the present embodiment can also be applied to the exemplary configuration illustrated in FIG. 2 of the first embodiment. Components having the same functions as those of the first embodiment are denoted by the same reference numerals as those of the first embodiment to omit redundant descriptions.

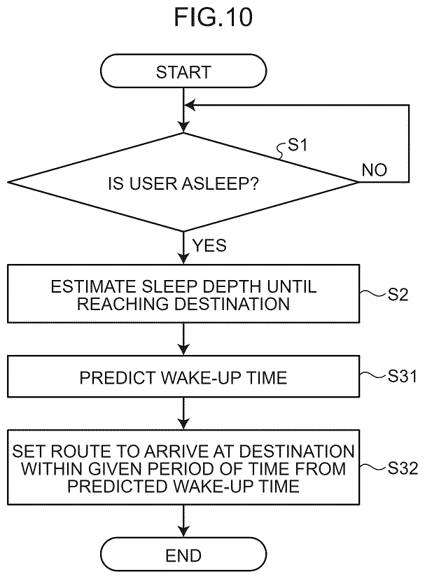

FIG. 10 is a flowchart illustrating an example of a processing procedure in the information processing device 3 of the present embodiment. Steps S1 and S2 are the same as steps S1 and S2 of the second embodiment. After step S2, the information processing device 3 predicts a wake-up time (step S31). Specifically, the estimation unit 31 predicts the user's wake-up time, using the estimated sleep depth. For example, the estimation unit 31 predicts the wake-up time, using the sleep depth estimation result and a standard human sleep pattern described in the first embodiment, and outputs the prediction result to the control information generation unit 32. Specifically, for example, the estimation unit 31 estimates the falling-asleep time and the sleep cycle, using the sleep depth estimation result, calculates a time period during which REM sleep will occur within a given period of time including an expected time of arrival at the destination, and sets a time within the calculated time period as a predicted wake-up time. For example, the estimation unit 31 may set the time at the center of the time period during which REM sleep will occur as the predicted wake-up time.

Next, the information processing device 3 sets a route to arrive at the destination within a given period of time from the predicted wake-up time (step S32). Specifically, the control information generation unit 32 determines a route to the destination of the vehicle 1 so that the vehicle 1 will arrive at the destination within a given period of time from the wake-up time predicted in step S31, generates route information that is control information indicating the determined route, and stores the route information in the information storage unit 34. Alternatively, the control information generation unit 32 may output the control information indicating the determined route to the travel control unit 33. By traveling based on the route information, the vehicle 1 can arrive at the destination within the given period of time from the predicted wake-up time. This can increase the possibility that the user will wake up naturally near the destination. Thus, the present embodiment also allows travel control according to a state related to the user's sleep.

In the above-described example, the wake-up time is predicted using the sleep depth, which is not limiting. The wake-up time may be set by the user, or may be estimated based on sleep information indicating at least one of the user's sleep history, a history of the user's wake-up times, or the scheduled wake-up time of the user, as described below.

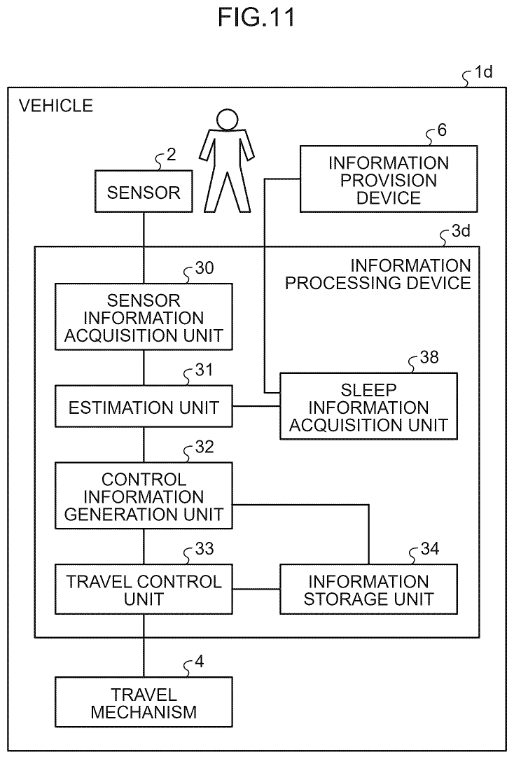

FIG. 11 is a diagram illustrating an exemplary configuration of a vehicle of the present embodiment that estimates a wake-up time using sleep information. As illustrated in FIG. 11, a vehicle 1d includes an information processing device 3d instead of the information processing device 3. The information processing device 3d is the information processing device 3 to which a sleep information acquisition unit 38 has been added. The sleep information acquisition unit 38 receives sleep information from an information provision device 6 that stores the user's sleep information, to acquire the sleep information, and outputs the acquired sleep information to the estimation unit 31. FIG. 11 illustrates an example in which the information provision device 6 is a mobile terminal such as a smartphone, a tablet, or a personal computer carried by the user, and the information provision device 6 is located in the vehicle 1d. However, the information provision device 6 may be located outside the vehicle 1d. The information provision device 6 is not limited to a mobile terminal carried by the user, and may be a server device or the like that manages sleep information of a plurality of users.

The sleep information is, for example, information managed by a sleep app (application software) that acquires and manages information on the user's sleep, but is not limited thereto. For example, the information provision device 6 may have an alarm function, and a wake-up time set in the alarm function may be used as the sleep information. In the case where the information provision device 6 has a schedule management function and the user has registered a wake-up time in a schedule, the registered wake-up time may be used as the sleep information.

The sleep information managed by the sleep app includes, for example, the user's falling-asleep time, wake-up time, and sleep cycle. In the case of predicting the wake-up time, using the sleep information managed by the sleep app, the estimation unit 31 may calculate, for example, the mean value of wake-up times using a history of the user's wake-up times, and use the calculated mean value as the predicted value of the wake-up time. Alternatively, the estimation unit 31 may calculate the mean value of sleep times using a history of falling-asleep times and wake-up times, estimate the user's falling asleep times, using the sensor information, and use the time at which the calculated mean value has elapsed since the estimated falling-asleep time as the predicted value of the wake-up time.

In the case where the sleep information is the wake-up time set in the alarm function, the estimation unit 31 may use the wake-up time indicated by the sleep information as the predicted value of the wake-up time. In the case where the sleep information is the wake-up time registered in the schedule, the estimation unit 31 may use the wake-up time indicated by the sleep information as the predicted value of the wake-up time. In the case where a schedule of a day on which the wake-up time is to be predicted has been registered, a wake-up time in the schedule of the day on which the wake-up time is to be predicted may be used as the predicted value of the wake-up time. In the case where a schedule of a day on which the wake-up time is to be predicted has not been registered, a registered wake-up time on another day of the same day of the week may be used as the predicted value of the wake-up time, or the wake-up time registered most among registered wake-up times may be used as the predicted value of the wake-up time.

The information processing device 3d illustrated in FIG. 11 is implemented, for example, by the processing circuitry illustrated in FIG. 3. The sleep information acquisition unit 38 is implemented by the communication unit 103.

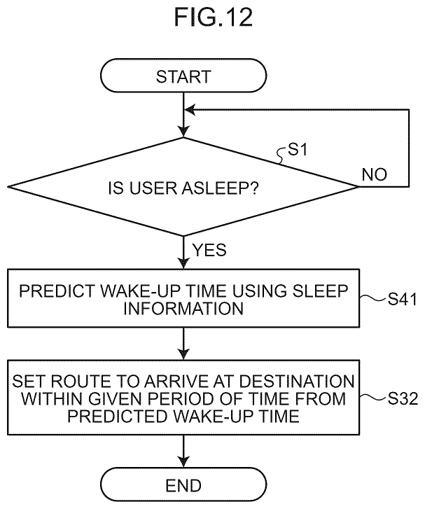

FIG. 12 is a flowchart illustrating an example of a processing procedure in the information processing device 3d of the present embodiment that predicts the wake-up time using the sleep information. Step S1 is the same as that in the example illustrated in FIG. 10. If Yes in step S1, the information processing device 3d predicts the wake-up time using the sleep information (step S41). Specifically, the estimation unit 31 predicts the user's wake-up time, using the sleep information received from the sleep information acquisition unit 38, and outputs the prediction result to the control information generation unit 32. Step S32 is the same as that in the example illustrated in FIG. 10.

The sleep information acquisition unit 38 may be added to the vehicle 1a or the information processing device 3a illustrated in FIG. 2 of the first embodiment. The information processing device 3a may predict the user's wake-up time, based on the sleep information as in the present embodiment, and set a route to arrive at the destination within the given period of time from the predicted wake-up time.

The information processing device 3d may perform at least one of the operation of the second embodiment or the operation of the third embodiment, and the operation described in the present embodiment. The vehicle 1a and the information processing device 3a illustrated in FIG. 2 may perform at least one of the operation of the second embodiment or the operation of the third embodiment and the operation described in the present embodiment.

As described above, in the present embodiment, the wake-up time is predicted, and the route is set so that the vehicle 1d will arrive at the destination within the given period of time from the predicted wake-up time. This can increase the possibility that the user will wake up naturally near the destination, increasing user comfort.

### Fifth Embodiment

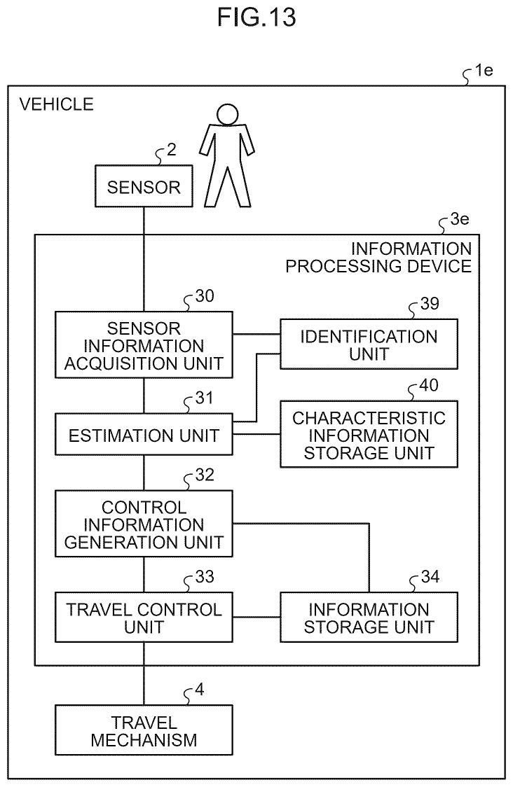

FIG. 13 is a diagram illustrating an exemplary configuration of a vehicle 1e according to a fifth embodiment. The vehicle 1e of the present embodiment is the same as the vehicle 1 of the first embodiment except that an information processing device 3e is included instead of the information processing device 3. Components having the same functions as those of the first embodiment are denoted by the same reference numerals as those of the first embodiment to omit redundant descriptions.

As illustrated in FIG. 13, the information processing device 3e is the information processing device 3 of the first embodiment to which an identification unit 39 and a characteristic information storage unit 40 have been added. Here, a configuration in which the information processing device 3e is provided in the vehicle 1e as illustrated in FIG. 1 of the first embodiment will be described as an example. However, in the exemplary configuration illustrated in FIG. 2 of the first embodiment, the identification unit 39 and the characteristic information storage unit 40 may be added to the information processing device 3a, and the operation of the present embodiment may be performed.

In the present embodiment, the sensor 2 includes, for example, a camera, and the sensor information includes captured-image data acquired by the camera capturing images of the user. The sensor information acquisition unit 30 outputs the captured-image data to the identification unit 39. The identification unit 39 identifies the user using the captured-image data, and outputs the identification result (user identification result) to the estimation unit 31. User identification may be the identification of the individual user or the identification of an attribute of the user. The attribute includes, but is not limited to, for example, at least one of gender or age.

User identification is performed using, for example, a facial recognition technology. In the case where the identification unit 39 identifies the individual user, image data indicating an image of the user's face has been registered in advance, and the identification unit 39 compares the registered image data with the captured-image data to identify the individual user. The age may not be the age itself, and may be indicated by a category such as infants, children, or adults, or may be indicated by a category such as an age group like under 10, 10s, or 20s. Age categories are not limited to these examples. In the example illustrated in FIG. 13, the identification unit 39 identifies the user based on the captured-image data, but may identify the user using the vital data acquired as the sensor information, or may identify the user using a combination of the captured-image data and the vital data.

The characteristic information storage unit 40 stores characteristic information indicating a sleep-related characteristic of each user or each attribute. The characteristic information includes, for example, at least one of information pieces indicating the user's sleep cycle, sleep time, or wake-up time, the characteristics of vital data at each sleep depth, the characteristics of the user's body movement at each sleep depth, the characteristics of vital data of body movement during sleep and during waking, the characteristics of body movement during sleep and during waking, and the like, and is used in estimation by the estimation unit 31. The characteristic information may be information in a table format in which data of each item is stored for each user, or may be a learned model learned by machine learning as described below. In the case where the characteristic information is information in a table format, the characteristic information is calculated, for example, by statistically processing data accumulated in advance for each user or each attribute. Alternatively, the characteristic information may be calculated based on the sensor information acquired by the sensor 2 when the user has ridden in the vehicle 1e in the past.

The estimation unit 31 estimates a sleep-related index, using the identification result received from the identification unit 39 and the characteristic information stored in the characteristic information storage unit 40. The sleep-related index may be the sleep depth, the wake-up time, the classification of whether or not the user is asleep, or two or more of them. That is, in the determination in step S1 illustrated in FIGS. 4, 7, 8, 10, or 12, the estimation unit 31 may estimate whether or not the user is asleep, using the identification result received from the identification unit 39 and the characteristic information stored in the characteristic information storage unit 40. In the estimation of whether or not the user is asleep, for example, at least one of information pieces indicating the characteristics of vital data of body movement during sleep and during waking, the characteristics of body movement during sleep and during waking, or the like is used as the characteristic information.

In the estimation of the sleep depth in FIGS. 4, 7, 8, or 10, the estimation unit 31 may estimate the sleep depth using the identification result received from the identification unit 39 and the characteristic information stored in the characteristic information storage unit 40. In the estimation of the user's sleep depth, for example, at least one of information pieces indicating the user's sleep cycle, the characteristics of vital data at each sleep depth, the characteristics of the user's body movement at each sleep depth, or the like is used as the characteristic information. When estimating the wake-up time described in the fourth embodiment, the estimation unit 31 may estimate the sleep depth using the identification result received from the identification unit 39 and the characteristic information stored in the characteristic information storage unit 40. In the estimation of the user's wake-up time, for example, at least one of information pieces indicating the sleep time, the wake-up time, or the like is used as the characteristic information. In this case, the characteristic information may be the actual value of at least one of the user's wake-up time or sleep time.

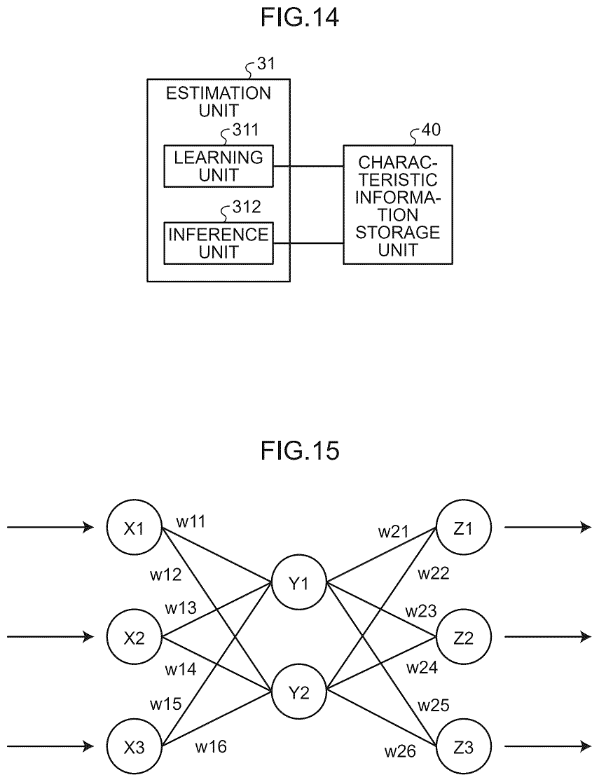

As described above, the characteristic information may be a learned model. FIG. 14 is a diagram illustrating an exemplary configuration of the estimation unit 31 of the present embodiment in the case where estimation is performed using machine learning. In the example illustrated in FIG. 14, the estimation unit 31 includes a learning unit 311 and an inference unit 312. For example, the learning unit 311 generates a learned model by supervised learning, using a plurality of data sets each including input data that is features and the sleep-related index that is corresponding answer data, and stores the generated learned model in the characteristic information storage unit 40 as the characteristic information. For example, the features include information calculated from the sensor information.

In the case where the learned model is a model for inferring the classification of whether or not the user is asleep, the input data includes, for example, at least one of information pieces indicating the characteristics of vital data of body movement during sleep and during waking, the characteristics of body movement during sleep and during waking, and the like. In the case where the learned model is a model for inferring the sleep depth, the input data includes, for example, at least one of information pieces indicating the user's sleep cycle, the characteristics of vital data at each sleep depth, the characteristics of the user's body movement at each sleep depth, and the like. The input data may be data calculated from data acquired by the sensor 2 in the past, or may be data calculated from data acquired by a device other than the sensor 2, or may be a mixture thereof. The input data may be data acquired by a sleep app or the like. The answer data may be determined, for example, by separately acquiring brain waves and using the brain waves, or may be determined based on the result of giving a stimulus to the user, or may be determined by a method other than these.

As an algorithm of supervised learning used to generate the learned model in the learning unit 311, any algorithm may be used. For example, a neural network model may be used. A neural network is composed of an input layer consisting of a plurality of neurons, an intermediate layer (hidden layer) consisting of a plurality of neurons, and an output layer consisting of a plurality of neurons. The intermediate layer may be one of two or more intermediate layers.

FIG. 15 is a schematic diagram illustrating an example of a neural network. For example, in a three-layer neural network as illustrated in FIG. 15, when a plurality of inputs are input to an input layer (X1 to X3), the values are multiplied by weights W1 (w11 to w16) and input to an intermediate layer (Y1 and Y2), and the results are further multiplied by weights W2 (w21 to w26) and output from an output layer (Z1 to Z3). The output results vary depending on the values of the weights W1 and the values of the weights W2.

In the present embodiment, the relationship between the features and the answer data is learned by adjusting the weights W1 and the weights W2 so that the output from the output layer when the features are input approaches the sleep-related index that is the answer data. Note that the machine learning algorithm is not limited to the neural network, and may be another algorithm such as a support vector machine. Machine learning used to generate the learned model in the learning unit 311 is not limited to supervised learning, and may be reinforcement learning or the like.

The inference unit 312 calculates the features using the sensor information received from the sensor information acquisition unit 30, and inputs the features to the learned model stored in the characteristic information storage unit 40 to infer the sleep-related index. Consequently, the sleep-related index is estimated.

The learned model may be generated for each individual user or each attribute. For example, the learned model may be generated for each age group. In the case where the identification result is an individual user's identification result, the estimation unit 31 infers the sleep-related index, using the learned model corresponding to the individual user. In the case where the identification result is a user attribute's identification result, the estimation unit 31 infers the sleep-related index, using the learned model corresponding to the attribute. Alternatively, instead of generating the learned model for each individual user or each attribute, the learned model may be generated by also inputting an individual user's identification information or attribute as features. At the time of inference, the individual user's identification information or attribute may also be input to the learned model as features.

FIG. 14 illustrates an example in which the estimation unit 31 includes the learning unit 311, which is not limiting. A learning device that generates a learned model may be provided separately from the vehicle 1e. The learning device may generate a learned model, and the learned model generated by the learning device may be stored in the characteristic information storage unit 40.

The information processing device 3e illustrated in FIG. 13 is implemented, for example, by the processing circuitry illustrated in FIG. 3. The identification unit 39 illustrated in FIG. 13 is implemented by the processor 101 illustrated in FIG. 3 executing a program stored in the memory 102 illustrated in FIG. 3. The memory 102 illustrated in FIG. 3 is also used to implement the identification unit 39 illustrated in FIG. 13. The characteristic information storage unit 40 illustrated in FIG. 13 is part of the memory 102 illustrated in FIG. 3.

The operation of the present embodiment is applicable to the estimation of the sleep-related index in any one of the first to fourth embodiments or a combination of two or more of the first to fourth embodiments.

As described above, in the present embodiment, the individual user or the user's attribute is identified, and the sleep-related index such as the classification of whether or not the user is asleep, the sleep depth, or the wake-up time is estimated, based on the identification result. This can provide the same effects as those of the first embodiment, and can increase the accuracy of estimation of the sleep-related index.

The information processing device according to the present disclosure achieves an effect of being able to perform travel control of the vehicle according to a state related to the user's sleep.

The configurations described in the above embodiments illustrate an example, and can be combined with another known art. The embodiments can be combined with each other. The configurations can be partly omitted or changed without departing from the gist.

What is claimed is:

1. An information processing device comprising:
estimation circuitry to estimate sleep depth of a user riding in a vehicle during sleep, using sensor information acquired by a sensor to detect at least one of a state of the user or an environment around the user; and
control information generation circuitry to generate control information to be used to control travel of the vehicle by automatic driving, using the sleep depth estimated by the estimation circuitry, wherein
the estimation circuitry estimates the sleep depth for a given period of time ahead,
the control information generation circuitry determines a period during which the user's sleep is predicted to be light, using the sleep depth for the given period of time ahead estimated by the estimation circuitry, determines a route of the vehicle so that the vehicle will arrive at a parking place within the determined period, and generates the control information indicating the determined route, and
the control information generation circuitry generates the control information to park the vehicle in the parking place, and generates the control information indicating causing the vehicle to depart from the parking place and resume travel when, after the vehicle arrives at the parking place and the vehicle is parked in the parking place, the control information generation circuitry determines that the user's sleep is deep, using a result of estimation of the sleep depth estimated by the estimation circuitry based on the sensor information acquired while the vehicle is parked in the parking place.

2. The information processing device according to claim 1, wherein the parking place includes at least one of a service area or a parking area.

3. The information processing device according to claim 1, wherein the control information generation circuitry generates the control information to make the travel of the vehicle gentler travel than in a normal time without limits, when the control information generation circuitry determines that the user's sleep is light, using the sleep depth estimated by the estimation circuitry.

4. The information processing device according to claim 3, wherein the gentler travel includes travel on a route with fewer uneven road surfaces.

5. The information processing device according to claim 3, wherein the gentler travel includes travel on a route with fewer sharp curves.

6. The information processing device according to claim 3, wherein the gentler travel includes travel in which at least one of acceleration of the vehicle or speed of the vehicle is lower than or equal to a threshold value.

7. The information processing device according to claim 1, wherein the control information generation circuitry operates a sound reduction device to reduce sound in the vehicle, when the control information generation circuitry determines that the user's sleep is light, using the sleep depth estimated by the estimation circuitry.

8. The information processing device according to claim 1, wherein the control information generation circuitry operates a light reduction device to reduce light in the vehicle, when the control information generation circuitry determines that the user's sleep is light, using the sleep depth estimated by the estimation circuitry.

9. The information processing device according to claim 1, wherein
the estimation circuitry predicts the user's wake-up time, using the estimated sleep depth, and
the control information generation circuitry determines a route of the vehicle so that the vehicle will arrive at a destination within a given period of time from the wake-up time predicted by the estimation circuitry, and generates the control information indicating the determined route.

10. The information processing device according to claim 9, comprising:
identification circuitry to identify the user; and
characteristic information acquisition circuitry to acquire characteristic information indicating a sleep-related characteristic of each user, wherein
the estimation circuitry predicts the wake-up time, using a result of identification by the identification circuitry and the characteristic information.

11. The information processing device according to claim 10, wherein the characteristic information includes an actual value of at least one of the user's wake-up time or sleep time.

12. The information processing device according to claim 1, comprising:
identification circuitry to identify the user; and
characteristic information acquisition circuitry to acquire characteristic information indicating a sleep-related characteristic of each user, wherein
the estimation circuitry estimates the sleep depth, using a result of identification by the identification circuitry and the characteristic information.

13. The information processing device according to claim 1, comprising:
identification circuitry to identify an attribute of the user; and
characteristic information acquisition circuitry to acquire characteristic information indicating a sleep-related characteristic of each attribute, wherein
the estimation circuitry estimates the sleep depth, using the attribute identified by the identification circuitry and the characteristic information.

14. The information processing device according to claim 12, wherein the characteristic information is a learned model generated by supervised learning using a plurality of data sets each including features calculated using the sensor information and the sleep depth that is corresponding answer data.

15. An information processing device comprising:
estimation circuitry to estimate sleep depth of a user riding in a vehicle, using sensor information acquired by a sensor to detect at least one of a state of the user or an environment around the user;
control information generation circuitry to generate control information to be used to control travel of the vehicle by automatic driving, using the sleep depth estimated by the estimation circuitry; and
input receiving circuitry to receive input of a selection result of the user's selection of whether or not to get out of the vehicle at a parking place, wherein the estimation circuitry estimates the sleep depth for a given period of time ahead,
the control information generation circuitry determines a period during which the user's sleep is predicted to be light, using the sleep depth for the given period of time ahead estimated by the estimation circuitry, determines a route of the vehicle so that the vehicle will arrive at the parking place within the determined period, and generates the control information indicating the determined route, and
when the selection result indicates that the user will get out of the vehicle at the parking place, the control information generation circuitry performs control to cause an awakening promotion device in the vehicle to awaken the user when the vehicle arrives at the parking place, and when the selection result indicates that the user will not get out of the vehicle at the parking place, the control information generation circuitry does not perform the control to cause the awakening promotion device to awaken the user even when the vehicle arrives at the parking place.

16. A vehicle capable of travel by automatic driving, the vehicle comprising:
estimation circuitry to estimate sleep depth of a user riding in the vehicle during sleep, using sensor information acquired by a sensor to detect at least one of a state of the user or an environment around the user;
control information generation circuitry to generate control information to be used to control travel of the vehicle, using the sleep depth estimated by the estimation circuitry; and
travel control circuitry to control travel of the vehicle by the automatic driving, using the control information, wherein
the estimation circuitry estimates the sleep depth for a given period of time ahead,
the control information generation circuitry determines a period during which the user's sleep is predicted to be light, using the sleep depth for the given period of time ahead estimated by the estimation circuitry, determines a route of the vehicle so that the vehicle will arrive at a parking place within the determined period, and generates the control information indicating the determined route, and
the control information generation circuitry generates the control information to park the vehicle in the parking place, and generates the control information indicating causing the vehicle to depart from the parking place and resume travel when, after the vehicle arrives at the parking place and the vehicle is parked in the parking place, the control information generation circuitry determines that the user's sleep is deep, using a result of estimation of the sleep depth estimated by the estimation circuitry based on the sensor information acquired while the vehicle is parked in the parking place.

17. A vehicle control method in an information processing device to control a vehicle capable of travel by automatic driving, the method comprising:
estimating sleep depth of a user riding in the vehicle during sleep for a given period of time ahead, using sensor information acquired by a sensor to detect at least one of a state of the user or an environment around the user; and
determining a period during which the user's sleep is predicted to be light, using the estimated sleep depth for the given period of time ahead, determining a route of the vehicle so that the vehicle will arrive at a parking place within the determined period, and generating control information to be used to control travel of the vehicle by the automatic driving, the control information indicating the route, wherein
in the generating, the control information to park the vehicle in the parking place is generated, and the control information indicating causing the vehicle to depart from the parking place and resume travel is generated when, after the vehicle arrives at the parking place and the vehicle is parked in the parking place, it is determined that the user's sleep is deep, using a result of estimation of the sleep depth estimated in the estimating, based on the sensor information acquired while the vehicle is parked in the parking place.

18. A non-transitory storage medium storing a program causing a computer system that controls a vehicle capable of travel by automatic driving to perform:
estimating sleep depth of a user riding in the vehicle during sleep for a given period of time ahead, using sensor information acquired by a sensor to detect at least one of a state of the user or an environment around the user; and
determining a period during which the user's sleep is predicted to be light, using the estimated sleep depth for the given period of time ahead, determining a route of the vehicle so that the vehicle will arrive at a parking place within the determined period, and generating control information to be used to control travel of the vehicle by the automatic driving, the control information indicating the route, wherein
in the generation, the control information to park the vehicle in the parking place is generated, and the control information indicating causing the vehicle to depart from the parking place and resume travel is generated when, after the vehicle arrives at the parking place and the vehicle is parked in the parking place, it is determined that the user's sleep is deep, using a result of estimation of the sleep depth estimated in the estimating, based on the sensor information acquired while the vehicle is parked in the parking place.
